(19) United States
(12) Patent Application Publication
(10) Pub. No.: US 2005/0241421 A1
(43) Pub. Date: Nov. 3, 2005

(54) Transmission device and application to a metering device

(76) Inventor: Genevieve Guerin-Schmitt, Seclin (FR)

Correspondence Address: EGBERT LAW OFFICES, 412 MAIN STREET, 7TH FLOOR, HOUSTON, TX, 77002, US

(21) Appl. No.: 10/525,355

(22) PCT Filed: Oct. 8, 2003
(86) PCT No.: PCT/FR03/02969

§ 371 Date: Feb. 23, 2005

(30) Foreign Application Priority Data
Oct. 15, 2002 (FR) 02/12816

(51) Int. Cl. B05C 17/01

(52) U.S. Cl. 74/130; 74/126

(57) ABSTRACT

The transmission device for transforming at least an oscillating motion into a rotational one-way linear movement includes an actuator oscillating about an axis of oscillation, between two positions, in a first so-called driving direction, and in a second so-called reverse direction, opposite the driving direction; a wheel provided with an axis of rotation, the axis of oscillation of the actuator and the axis of rotation of the wheel merging; a butt driving device for the wheel, secured to the actuator, capable of driving the wheel in a first so-called forward direction; and a butt locking device for the wheel, capable of preventing the wheel from rotating. A device dispenses controlled doses of a liquid, pasty or viscous substance, in particular a sealing product, using such a transmission device.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a device for transforming an oscillating movement into a unidirectional, rotational and/or linear movement, as well as its application to a device for distributing controlled doses of a finishing product, notably.

### BACKGROUND OF THE INVENTION

To transform an oscillating movement or a rotational unidirectional movement, the state of art provides snapping systems wherein a ratchet, for example interconnected with an oscillating arm, engaged onto a pinion when the arm is moved into one direction and drives the pinion when the arm is moved into the other direction. The movement is therefore transmitted mainly thanks to the co-operation between the ratchet and the teeth of the pinion.

Still, a pinion exhibits a finished number of teeth, which correspond each to a potential driving point. Consequently, as long as the ratchet has not switched from one tooth to the next, the device shows certain clearance and it does not operate with maximum efficiency as of the first driving movement of the oscillating arm.

Besides, devices for distributing finishing products are known, such as mastic guns, to apply notably a finishing product to a determined zone. In such devices, there is a tank fitted with a piston which, generally, is brought into rotation in the tank thanks to a spring-loaded system connected to a trigger. However, such systems show certain inertia, notably because of the use of springs to bring said pinion into motion.

Thus, such systems do not enable to control precisely the dose of product applied nor its output speed from the tank. There exists indeed a transitory period, relatively long with respect to the distribution duration of the product, during which the distribution speed of the product will increase before stabilizing.

Moreover, such distribution devices cause losses of the product applied since generally the dose distributed is vastly greater than that truly necessary. These devices do not enable to avoid burrs which will have to be cleaned eventually.

The purpose of the present invention is to provide a transmission device as well as a device for distributing controlled doses, implementing such a transmission device, which remedies the shortcomings aforementioned. In particular, an object of the present invention is to provide a transmission device to transform an oscillating movement into a unidirectional, rotational and/or linear movement, which does not exhibit any clearance. Thus, such a device will exhibit increased transmission efficiency relative to known transmission devices moreover.

It is another object of the present invention to provide a device for distributing doses of a liquid, viscous or pasty material, such as a finishing product implementing such a transmission device, enabling to control precisely the quantity of material applied.

It is another object of the present invention to provide a device for distributing an optimal dose of material to be applied, this dose being sufficient to ensure that the effect requested is obtained without it being necessary to clean off possible burrs at a later stage.

Other objects and advantages of the present invention will appear in the following description, which is given only for exemplification purposes and without being limited thereto.

### BRIEF SUMMARY OF THE INVENTION

The present invention concerns first of all a transmission device for transforming at least one oscillating movement into a unidirectional rotational movement comprising:
an actuator oscillating round an oscillating axle, between two positions, in a first so-called driving direction, and in a second so-called return direction, opposite said driving direction,
a wheel fitted with a rotational axle, whereas the oscillating axle 2 of said actuator 1 and the rotational axle of said wheel 4 are merged,
means for driving said wheel by a bracing effect, slaved to said actuator, capable of driving said wheel into a first so-called forward direction,
means for locking said wheel by a bracing effect, capable of preventing said wheel from rotating into another so-called backward direction, opposite the forward direction.

The present invention also concerns a transmission device for transforming an oscillating movement into a unidirectional linear movement implementing a transmission device for transforming an oscillating movement into a unidirectional rotational movement, wherein a pinion co-operates with the rotational axle of said wheel on the one hand, and engages into a rack on the other hand.

The present invention also concerns a device for distributing controlled doses of a liquid, pasty or viscous material, notably a sealing product, implementing a transmission device capable of transforming an oscillating movement into a unidirectional linear movement.

### BRIEF DESCRIPTION OF THE SEVERAL VIEWS OF THE DRAWINGS

The invention will be better understood when reading the description, in conjunction with the appended drawings, wherein:

FIG. 1 is an exploded perspective view of a transmission device according to the invention,

FIG. 2 is a perspective view of the device of FIG. 1, the parts being assembled,

FIGS. 3 to 6 respectively are forward, right-hand, backward and left-hand projections of the device illustrated on FIG. 2,

FIG. 7 is an enlarged view of the transmission device illustrated on FIG. 6, after removal of the lid from the box,

FIGS. 8, 9 and 10 are bottom, edgewise and top projections, respectively, illustrating the driving and locking means of the invention,

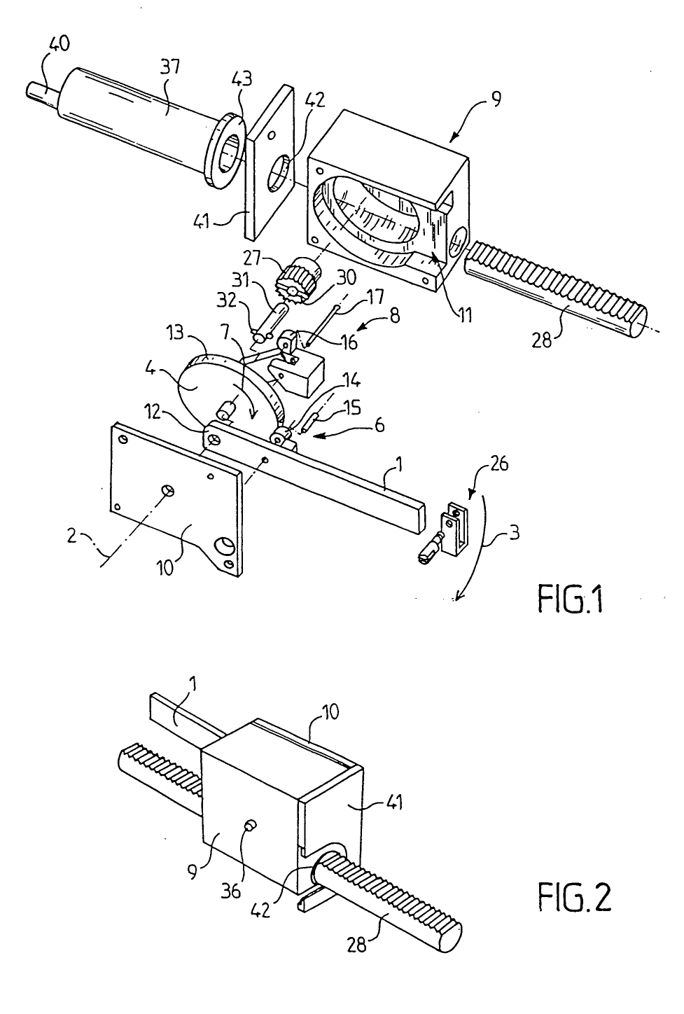

FIG. 1I is a view of disengageable means used in a device for transforming a unidirectional rotational movement into a unidirectional linear movement,

FIG. 12 illustrates a device for distributing controlled doses of a liquid, pasty or viscous material, according to the invention,

FIG. 13 represents schematically a device for installing fastening elements fitted with a distribution device according to the invention.

### DETAILED DESCRIPTION OF THE INVENTION

As illustrated on FIG. 1, the present invention concerns a transmission device for transforming at least one oscillating movement into a unidirectional rotational movement.

According to the invention, such a transmission device comprises an actuator 1 oscillating round an oscillating axle 2. This device may oscillate between two positions, notably extreme upper and lower positions. For example, it may oscillate into a first direction, designated by the arrow 3, from top to bottom, and into a second opposite direction. Said first direction will be called driving direction and said opposite direction will be called return direction.

The device also includes a wheel 4 fitted with a rotational axle 5.

Finally, the transmission device according to the invention also includes:
means 6 for driving said wheel 4 by a bracing effect,
means 8 for locking said wheel 4 by a bracing effect.

Said driving means 6 are slaved to said actuator 1 and are capable of driving said wheel 4 into a first so-called forward direction, illustrated by the arrow 7.

Said locking means 8 are capable of preventing said wheel 4 from rotating into a second so-called backward direction, opposite said forward direction 7.

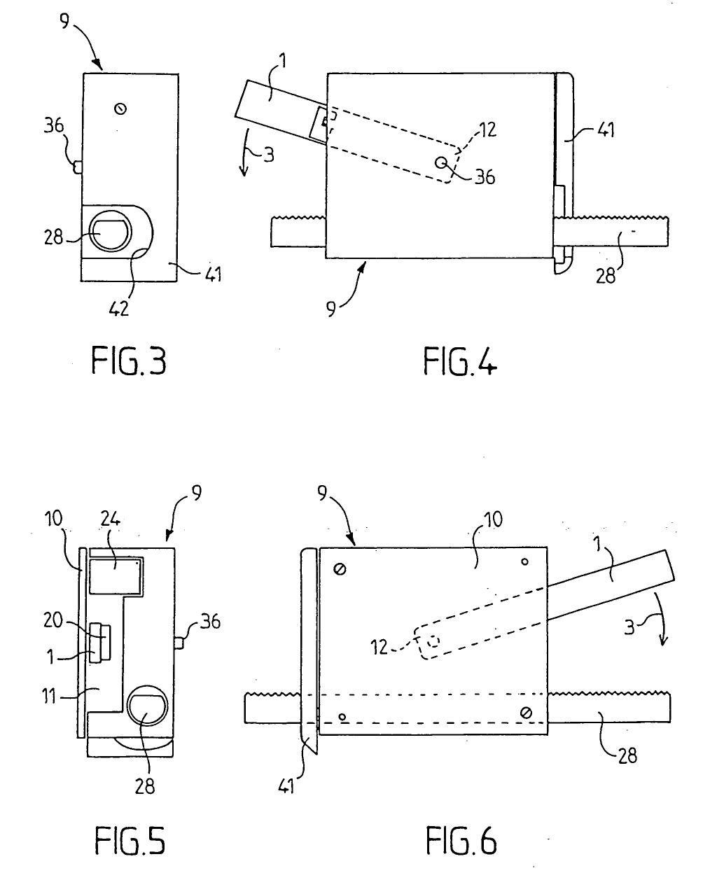

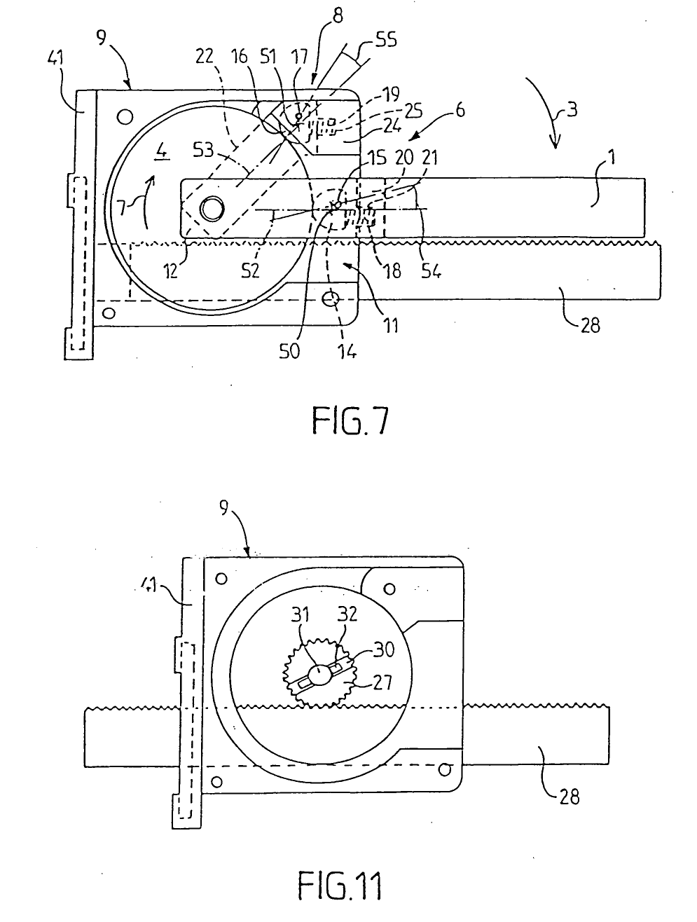

Advantageously, said wheel 4, said driving means 6 and said locking means 8 are brought together inside a box 9 which protects said items and maintains them in their respective positions, as illustrated on FIGS. 2 to 6.

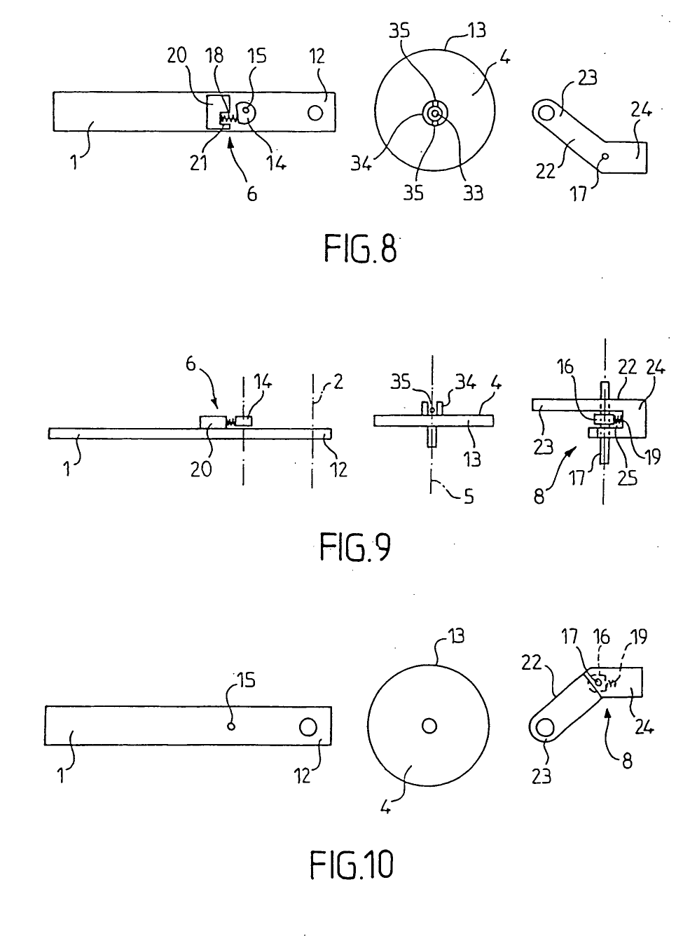

Said box 9 is fitted with a lid 10 which, once removed, as shown on FIG. 7, enables to access the mechanism of the transmission device. Thus, said box 9 may act as a bracket for the rotational axle 2 of said wheel. It is also fitted with an opening 11 at the back to enable the oscillation movements of the actuator.

Besides, the means 8 for locking said wheel 4 maintains a fixed position relative to said box 9.

Moreover, advantageously, the oscillating axle 2 of said actuator 1 and the rotational axle 5 of said wheel 4 are merged.

Said actuator 1 may be in the form of a lever 1 whereof one end 12 is hinged to the rotational axle 5 of said wheel 4.

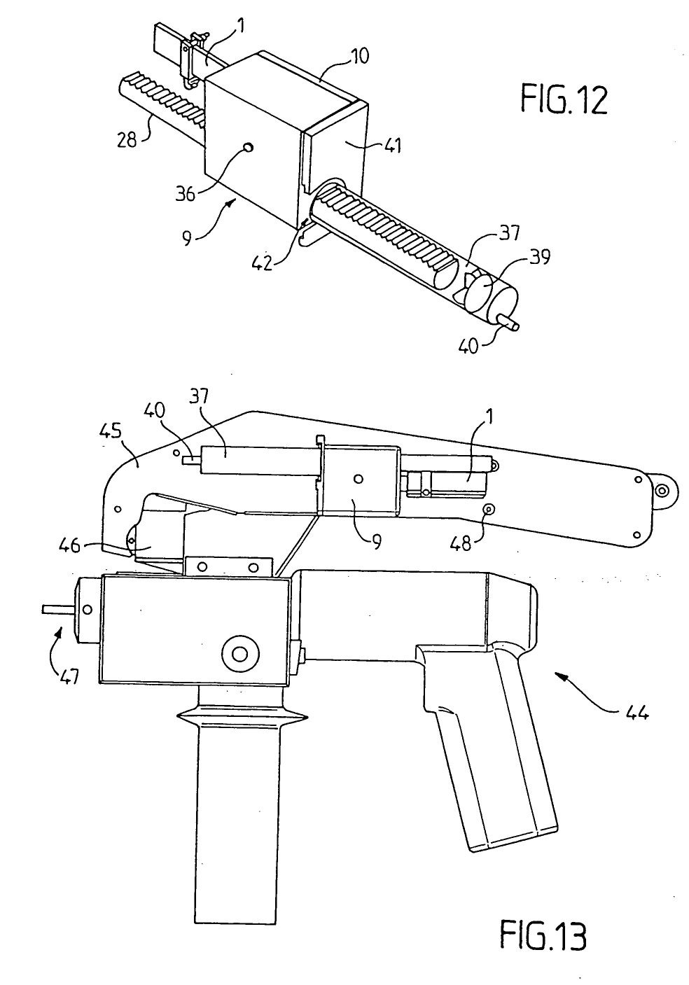

As illustrated on FIG. 1 and on FIGS. 8 to 10, said wheel 4 has a smooth edge 13. The driving means 6 and locking means 8 co-operate with said edge 13 of the wheel 4.

The driving means are in the form of an eccentric 14 slaved to said lever 1 at its rotational axle by an axle 15. Thus, the distance between the rotational axle of the driving eccentric 14 and the rotational axle 5 of said wheel remains constant.

During the oscillating movement of the lever 1 around the rotational axle 5 of the wheel 4, the driving eccentric 14, driven by friction, will finally brace against said wheel 4. Thus, said wheel 4 is driven by said lever 1, via the driving eccentric 14.

When the lever 1 moves in the return direction, the driving eccentric 14 will revolve slightly around its rotational axle and will not brace against said wheel. It will then be able to slide freely along the edge 13 of said wheel 4.

Similarly, said locking means 8 are in the form of a locking eccentric 16 whereof the rotational axle, materialized by an axle 17, remains at constant distance from the rotational axle 5 of said wheel 4.

The operating principle of the locking eccentric 16 is similar to that of the driving eccentric 14. As it appears that the locking means 8 remain fixed relative to the box 9 when said locking eccentric 16 braces against the wheel 4, it prevents the latter from rotating. It is this situation which takes place when the lever 1 moves into the return direction.

Conversely, when the lever 1 moves into the driving direction 3, said locking eccentric 16 undergoes slight rotation around its rotational axle and slides freely against the edge 13 of said wheel 4.

The operating cycle of the transmission device is therefore as follows: when the lever 1 moves into the driving direction 3, the driving eccentric 14 braces against said wheel 4 whereas the locking eccentric 16 undergoes slight rotation to be ‘free-wheeled’ relative to said wheel 4. Thus, the driving eccentric 14 may drive the wheel 4 into rotation, in the forward direction 7.

Then, when the lever 1 has reached the end of its travel, it moves into the return direction, to resume its initial position. In such a case, said driving eccentric 14 undergoes slight rotation to be ‘free-wheeled’ relative to said wheel 4 whereas said locking eccentric 16 braces against the edge 13 of said wheel 4.

The lever 1 may then resume freely its initial position whereas the locking means 8 prevent the wheel 4 from rotating in the reverse direction.

Advantageously, said driving 14 and locking 16 eccentrics are in the form of truncated rollers, fitted with a flat surface. For better contact between said eccentrics 14, 16 and said wheel 4, springs 18, 19 are provided, cooperating at least with said flat surface of said eccentrics 14, 16 to press said eccentrics against the edge 13 of said wheel 4.

Thus, said lever 1 is fitted with a toe 20 wherein a notch 21 is provided, housing said spring 18. Said notch 21 enables to maintain and to guide said spring 18. Said spring 18 acts on said flat surface of said driving eccentric 14 and thereby ensures constant contact between said driving eccentric 14 and said wheel 4.

As regards the locking means 8, it is advantageous to provide a bent arm 22 whereof an end 23 co-operates with the rotational axle 5 of said wheel 4, and the other end 24 is interconnected with said box 9. At the elbow of said bent arm 22, there is a notch 25 housing said spring 19, capable of co-operating with the flat surface of the locking eccentric 16. Here again, said notch 25 enables to maintain and to guide said spring 19.

Thus, said locking means 8 remain positioned correctly relative to said wheel 4.

Advantageously, said driving 14 and locking 16 eccentrics show an eccentricity of a few tenth millimeters, notably 3/10 millimeters for a 6 mm diameter.

FIG. 7 represents, exaggeratedly, on the one hand the rotational axle of said eccentrics 14, 16 materialized by the axles 15, 17 respectively, and on the other hand the center 50, 51 of the circle wherein said eccentric 14, 16 is inscribed. Eccentricity is defined as the distance between the rotational axle of the eccentric and the center of said circle.

For each eccentric 14, 16 the contact point between said eccentric 14, 16 and the wheel and the rotational axle of said eccentric 14, 16 are considered. Both these points delineate a straight line, called contact generatrix 52, 53, which forms an angle 54, 55 respectively with the straight line delineated by said contact point and the center 50, 51 of the circle wherein said eccentric 14, 16 is inscribed.

When said eccentric 14, 16 is brought into rotation, the position of said center 50, 51 relative to said contact generatrix 52, 53 changes. The amplitude of the contact angle 54, 55 may hence vary when said eccentric 14, 16 braces against said wheel 4, the contact angle 54, 55 has a minimal value, so-called pressure angle.

Thanks to said springs 18, 19, the contact between one said eccentric 14, 16 and said wheel 4 is held at any time and said contact angle 54, 55 remains constant. It is the direction of the loads exerted between said wheel 4 and said eccentrics 14, 16, which determines whether said eccentric 14, 16 braces or rubs/slides against the wheel.

As illustrated on FIG. 1, said lever 1 may be slaved to control means, via a dog 26. The control means describe advantageously an alternating movement, in that the path followed by said control means, in space, remains the same from one operating cycle to the next.

Advantageously, said dog 26 may be positioned alongside said lever 1, at variable distance from the oscillating axle 2 of said lever 1 or from the rotational axle 5 of said wheel 4. This arrangement authorizes a variable transmission coefficient of the alternating movement of the control means to the transmission device according to the invention.

Indeed, for a complete displacement cycle of the control means with constant amplitude, according to position of the dog 26 on the lever 1 n the oscillating angle of said lever around its oscillating axle 2, will vary. In particular, the closer the dog 26 to said oscillating axle 2, the greater the oscillating angle and the greater the corresponding rotational angle of said wheel 4.

The present application also concerns a transmission device for transforming an oscillating movement into a unidirectional linear movement implementing a transmission device, as evoked previously for transforming an oscillating movement into a unidirectional rotational movement and comprising moreover a pinion 27 co-operating with the rotational axle 5 of said wheel 4 on the one hand, and engaging into a rack 28 on the other hand.

Thus, when the lever 1 moves into the driving direction, it drives, thanks to the driving eccentric 14, said wheel 4. The latter drives said pinion, interconnected with the rotational axle 5 of said wheel 4 and said pinion 27 engages into said rack 28, which describes then a unidirectional linear movement.

As the locking eccentric 16 prevent the wheel 4 from rotating in the reverse direction, the pinion 27 may not rotate in the reverse direction either. Thus, the rack 28 is itself locked in the direction corresponding to said reverse direction of said wheel 4.

Advantageously, declutching means are provide to release said pinion 27 with respect to the rotational axle 5 of said wheel 4 and to bring said rack 28 back to its initial position by driving it into the direction contrary to its normal displacement direction.

Said pinion 27 is mounted on a shaft 31 whereof the end is fitted with a let-through orifice wherein a pin 32 is housed. Said pin 32 co-operates with a diametrical groove 30 of the end of the pinion 27. Thus, when said pin 32 is engaged into said groove 30, the rotation of the shaft 31 causes the pinion 27 to rotate.

Besides, a tube 34 interconnected with the wheel 4 is provided by its rotational axle 5. The length of the tube 34 is at least equal to one and a half times the diameter of the pin 32 placed at the end of the shaft 31 of the pinion 27. The inside diameter of said tube 34 is equal to that of the shaft 31 of the pinion 27, so that said tube 34 and said shaft 31 may co-operate.

Moreover, the wall of said tube 34 is fitted with two longitudinal notches 35, diametrically opposed, capable of co-operating with said pin 32. Thus, when said wheel 4 is brought into rotation, it is capable of driving said shaft 31 into rotation via the pin 32.

To declutch said pinion 27 from said wheel 5, a declutching spring 33 is placed at the bottom of said tube 34 so that in declutched position, said declutching spring presses onto said pin 32 so that it co-operates with said groove 30 of the pinion 27. The length of the shaft 31 is provided sufficient so that said shaft 31 protrudes from said box 9, at a declutching bolt 36.

By depressing said declutching bolt 36, said shaft 31 and therefore said pin 32 are pushed back to order to release said pin from said groove 30 of the pinion 27, and so that it does not co-operate with the pinion any longer. It is then possible to displace said rack 28 into the direction contrary to its normal displacement direction.

It should be noted that a transmission device for transforming an oscillating movement into a linear or rotational unidirectional movement, according to the invention, is irreversible. Indeed, because of the presence of the locking means 8, and given that the lever 1 may oscillate independently from the rotation of the wheel 4, it is not possible to transform a unidirectional rotational movement imparted to said wheel 4 into an oscillating movement of the lever 1.

Besides independently from the position of the dog 26 on the lever 1, complete oscillation of the lever 1, i.e. a movement into the driving direction 3 followed by a movement in the return direction, ends with a rotation and possibly a translation, of constant amplitude with time. It is possible to adjust said amplitude by setting the position of the dog 26 via which said control means act.

The present invention still concerns a device for distributing controlled doses of a liquid, pasty or viscous material, such as a finishing product, notably a sealing product, implementing a transmission device for transforming an oscillating movement into a unidirectional linear movement, said distribution device comprising moreover a tank 37 capable of containing said material, said rack 28 co-operating with means 39 to empty said tank 37 on a dose-to-dose basis.

Such a device is illustrated on FIG. 12. On this figure, said tank 37 is in the form of a cartridge or of a syringe fitted with a distribution nozzle 40 and with a piston which constitute said means 39 to empty said tank 37.

As illustrated, when said rack 28 moves by a pitch corresponding to the amplitude selected, a predetermined dose of the finishing product may be distributed.

As illustrated, the box 9 is fitted with a front cover 41 whereof the lower portion, wherein the rack 28 emerges, exhibits a substantially circular notch 42.

Moreover, said tank 37 is fitted at its end opposite the distribution nozzle 40, with wings 43. Said circular notch 42 is provided capable of receiving said wings 43 of the tank 37. It therefore acts as means for holding said tank.

Besides, this enables to change the used cartridge 37 very easily. Once a cartridge 37 emptied, it suffices to declutch the pinion 27 from the wheel 4 while depressing the declutching button 36, to bring the rack back to its initial position, then to remove the empty cartridge 37 by sliding it outside the hold-on notch 42 before installing a new cartridge 37.

Advantageously, one may use such a device for dosing a finishing material in a device 44 for laying fastening elements, for example a riveting device. Such a device for laying fastening elements is described in the documents of the patent FT-01/07822 and FR-02/07322.

These mechanisms exhibit notably a loading device 45 which brings from a fastening element, the ends of a means 46 for feeding fastening elements, to a means 47 for laying the fastening elements.

When operating the laying device, the loading means 45 tip with constant amplitude around its tilting axle 48.

Advantageously, one will be able to fix a dosing device according to the invention to a fixed point with respect to the loading means 45 described briefly. Moreover, one will be able to slave said lever 1 to said loading device 45, by means of a dog 26. Thus, the tilting movement of the loading device may be transmitted to said lever 1, thereby ensuring the operation of the dosing device.

Besides, the purpose being to bring a controlled dose of a finishing material at the fastening means, there is provided between the nozzle 40 of the cartridge 37 and the means holding the loading means, a flexible hose wherein said liquid, pasty or viscous finishing material may flow.

Naturally, other embodiments understandable to the man of the art cold have been contemplated without departing from the framework of the invention.

1. A transmission device for transforming at least one oscillating movement into a unidirectional rotational movement comprising:
an actuator oscillating round an oscillating axle, between two positions, in a first driving direction, and in a second return direction, opposite said driving, direction,
a wheel fitted with a rotational axle, the oscillating axle and the rotational axle of said wheel being merged,
means for driving said wheel by a bracing effect, slaved to said actuator, driving said wheel into a first forward direction, and
means for locking said wheel by a bracing effect, preventing said wheel from rotating into a backward direction, opposite the first forward direction.

2. A device according to claim 1, wherein said actuator is comprised of a lever, whereof one end being hinged to the rotational axle of said wheel.

3. A device according to claim 1, wherein said wheel exhibits a smooth edge; wherein the driving means and the locking means are each comprised of an eccentric co-operating with the smooth edge, distance between rotation of one eccentric and the rotational axle of said wheel remaining constant during operation; wherein, when said actuator moves into said driving direction, said driving eccentric braces against said wheel, for driving said wheel into rotation into said forward direction; wherein, when said actuator moves into the return direction, said locking eccentric braces against said wheel, to prevent said wheel from being brought into rotation into said reverse direction; and wherein one eccentric slides freely alongside the edge of said wheel when the other braces against the wheel.

4. A device according to claim 3, wherein said eccentric are comprised of truncated rollers, delineating a flat surface, said device further comprising:
springs co-operating with said flat surface of said eccentrics and maintaining contact between said eccentrics and said wheel.

5. A device according to claim 3, wherein said eccentric exhibit an eccentricity of 3/10 millimeter for a 6 mm diameter.

6. A device according to claim 2, wherein said lever is slaved, by a dog, to a control means describing an alternating movement, said dog being positioned alongside said lever, at variable distance from the oscillating axle of said lever, authorizing a variable transmission coefficient.

7. A device according to claim 1, further comprising:
a pinion co-operating with the rotational axle of said wheel and engaging into a rack, transforming said oscillating movement into a unidirectional linear movement.

8. A device according to claim 7, further comprising:
a declutching means to release said pinion relative to the rotational axle of said wheel.

9. A device for distributing controlled doses of a liquid, pasty or viscous material, notably a sealing product, comprising:
a transmission device according to claim 7,
a tank containing the material, and
a rack co-operating with means to empty said tank on a dose-to-dose basis.

10. A device according to claim 9, wherein said tank is comprised of a cartridge fitted with a distribution nozzle and with a piston, said rack co-operating with said piston to empty said tank on a dose-to-dose basis.
